(19) United States
(12) Patent Application Publication
(10) Pub. No.: US 2026/0236201 A1
(43) Pub. Date: Aug. 13, 2026

(54) IMAGE FORMING APPARATUS CAPABLE OF CALCULATING CO2 EMISSIONS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: TAKUYA MATSUMURA, Tokyo (JP)

(21) Appl. No.: 19/444,580

(22) Filed: Jan. 9, 2026

(30) Foreign Application Priority Data
Feb. 7, 2025 (JP) 2025-019405

(51) Int. Cl. G06F 3/12

(52) U.S. Cl. CPC G06F 3/1221; G06F 3/1204; G06F 3/121; G06F 3/1234; G06F 3/1241; G06F 3/1259; G06F 3/1273

(57) ABSTRACT

An image forming apparatus capable of allocating CO2 emissions to an appropriate account based on whether printed matter is normally output. The image forming apparatus generates printed matter by executing a plurality of processes including an image forming process according to a given print job. The image forming apparatus includes a memory device that stores a set of instructions, and at least one processor that executes the set of instructions to calculate CO2 emissions generated in the image forming apparatus, and allocate the CO2 emissions to an account selected according to whether the printed matter is normally output.

### BACKGROUND

### Field of the Technology

The aspect of the embodiments relates to an image forming apparatus capable of calculating carbon dioxide (CO2) emissions as environmental load amounts due to generation of printed matter, a control method therefor, and a storage medium storing a control program therefor.

### Description of the Related Art

In recent years, efforts have been made to calculate emission amounts of greenhouse gases such as CO2 in order to visualize an environmental load situation. In the field of image forming apparatuses, technologies have been proposed for calculating the amount of emitted greenhouse gases, such as CO2, because these apparatuses consume electric power and use consumable parts such as ink and toner to generate printed matter. For example, Japanese Patent Laid-Open No. 2006-21414 (JP2006-21414A) discloses a technique of an image forming apparatus that obtains amounts of color materials and sheets used and electric power consumption based on document data and job information defining an image formation mode in forming an image and calculates environmental load amounts (CO2 emissions) from these pieces of information.

In this way, the image forming apparatus disclosed in the above publication calculates the environmental load amount during the image forming process for printing on the basis of the document data and the job information. On the other hand, in commercial and industrial printing, a printing company receives input data from a client, generates printed matter by performing an image forming process using the input data, and generates a final product by performing a post process on the printed matter.

In such a case, the products are not always printed successfully, and a print failure (print abnormality) may occur, and thus the number of consumed sheets may be more than the number of requested sheets. A client wants to accept CO2 emissions due to generation of good products only. However, the technique disclosed in the publication allocates CO2 emissions due to troubleshooting of the apparatus and additional printing to cover a print failure to the client in addition to the CO2 emissions due to generation of good products as the CO2 emissions occurred in one print job. That is, the conventional technique does not take defective printed matter into consideration in calculating and allocating the CO2 emissions of the current products, and the CO2 emissions cannot be counted and allocated in consideration of the defective products generated in the apparatus.

### SUMMARY

The present disclosure provides an image forming apparatus, a control method therefor, and a storage medium storing a control program therefor, which are capable of allocating CO2 emissions to an appropriate account based on whether printed matter is normally output.

Accordingly, an aspect of the embodiments provides an image forming apparatus generating printed matter by executing a plurality of processes including an image forming process according to a given print job, the image forming apparatus including a memory device that stores a set of instructions, and at least one processor that executes the set of instructions to calculate CO2 emissions generated in the image forming apparatus, and allocate the CO2 emissions to an account selected according to whether the printed matter is normally output.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a print environment load amount calculation system.

FIG. 2 is a schematic sectional view of an image forming apparatus.

FIG. 3 is a block diagram illustrating a hardware configuration of the image forming apparatus.

FIG. 4A and FIG. 4B are explanatory diagrams of tables that define power consumptions of sections of the image forming apparatus.

FIG. 5A and FIG. 5B are explanatory diagrams of tables that define CO2 emissions in processes in the image forming apparatus.

FIG. 6 is a flowchart illustrating a printing process including a calculation process and an allocation process to calculate and allocate CO2 emissions of the image forming apparatus related to a first embodiment.

FIG. 7 is an explanatory diagram of hardware guarantee information about the image forming apparatus.

FIG. 8 is a flowchart illustrating an inspection process including a calculation process and an allocation process to calculate and allocate CO2 emissions of an image forming apparatus related to a second embodiment.

FIGS. 9A and 9B are flowcharts illustrating a calculation process and an allocation process to calculate and allocate CO2 emissions of an image forming apparatus having a recovery printing function.

FIGS. 10A and 10B are views illustrating examples of CO2 emission display screens in the second embodiment.

FIG. 11A is a sectional view of a cutting-and-binding apparatus and FIG. 11B is a diagram illustrating power consumptions thereof.

FIG. 12 is a block diagram illustrating a configuration of an environmental load calculation server related to a third embodiment.

FIG. 13 is a flowchart illustrating a process of the environmental load calculation server related to the third embodiment.

FIGS. 14A and 14B are views illustrating examples of CO2 emission display screens in the third embodiment.

### DESCRIPTION OF THE EMBODIMENTS

Hereinafter, embodiments of the present disclosure will be described in detail with reference to the attached drawings. However, the configurations described in the following embodiments are merely examples, and the scope of the present disclosure is not limited by the configurations described in the embodiments. In the specification, carbon dioxide is simply referred to as CO2 as appropriate. In addition, a manufacturer of an image forming apparatus is simply referred to as an apparatus manufacturer or a manufacture as appropriate, and a printing company is referred to as a contractor or a print contractor as appropriate.

In the present disclosure, the CO2 emissions are allocated to a client, a contractor, or a manufacturer depending on whether printed matter is normally output, and thus it is possible to reduce excessive CO2 emission allocation to the client. In the present disclosure, as an aspect, an account (an allocation destination) of the CO2 emissions calculated per job is selected according to a state of a product. For example, when the product is normal, the account for the CO2 emissions is set to the client. When the product is abnormal, the account is set to the manufacturer. The selection methods are not limited thereto. When printed matter is not output normally, the account for the CO2 emissions calculated may be selected between the contractor and the manufacturer according to guarantee information about the image forming apparatus.

In the embodiment according to the present disclosure described below, the image forming apparatus is described as an example, but the present disclosure is applicable to any business model as long as the business model has a configuration including at least a client and a contractor and an information processing apparatus capable of calculating CO2 emissions.

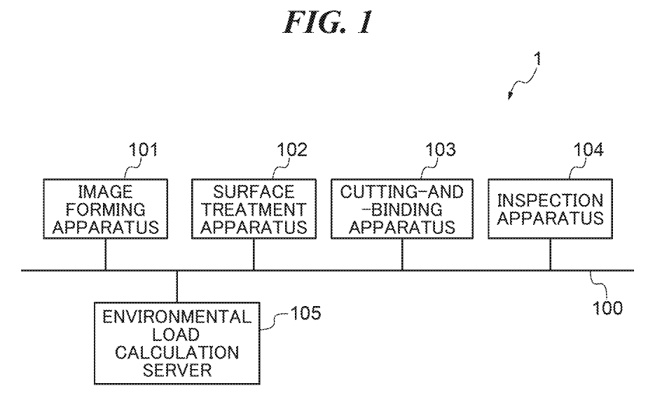

FIG. 1 is a block diagram illustrating an environmental load amount calculation system 1 according to the present embodiment. An image forming apparatus 101, a surface treatment apparatus 102, a cutting-and-binding apparatus 103, an inspection apparatus 104, and an environmental load calculation server 105 constituting the environmental load amount calculation system 1 are connected via a network 100 so as to communicate required information with each other. The image forming apparatus 101 receives a print instruction and print data from the outside via the network 100, feeds a sheet based on the received print data and print instruction, forms an image on the sheet, and ejects the sheet, thereby implementing printing. The surface treatment apparatus 102 processes surfaces of print sheets. The surface treatment apparatus 102 processes a surface of a print sheet, which is conveyed from a sheet feed unit of the image forming apparatus 101, using processing material, hardens and dries the surface to stabilize the surface processing on the print sheet, and conveys the sheet to a sheet ejection unit. In this manner, the surface treatment apparatus 102 functions as a pre-processing apparatus for the image forming apparatus 101.

The cutting-and-binding apparatus 103 cuts print sheets into a designated size and binds the sheets into a booklet. An apparatus having only one of a cutting function and a bookbinding function can be used as the cutting-and-binding apparatus 103. The inspection apparatus 104 inspects whether a series of steps to generate a product have been executed without any abnormality and inspects whether a preset product accuracy is satisfied. A 100% inspection to inspect all products or a sampling inspection to inspect samples randomly extracted from a target lot may be used.

The environmental load calculation server 105 calculates an environmental load amount corresponding to a product generated and inspected by the operations of the image forming apparatus 101, the surface treatment apparatus 102, the cutting-and-binding apparatus 103, and the inspection apparatus 104. In embodiments of the present disclosure, the environmental load amount corresponds to CO2 emissions. The environmental load calculation server 105 receives a job history and information about operations of the image forming apparatus 101, the surface treatment apparatus 102, and the cutting-and-binding apparatus 103 via the network 100, and calculates the environmental load amount based on the received information. In this manner, the environmental load calculation server 105 calculates and displays the CO2 emissions of the apparatuses that are connected via the network 100 and emit CO2.

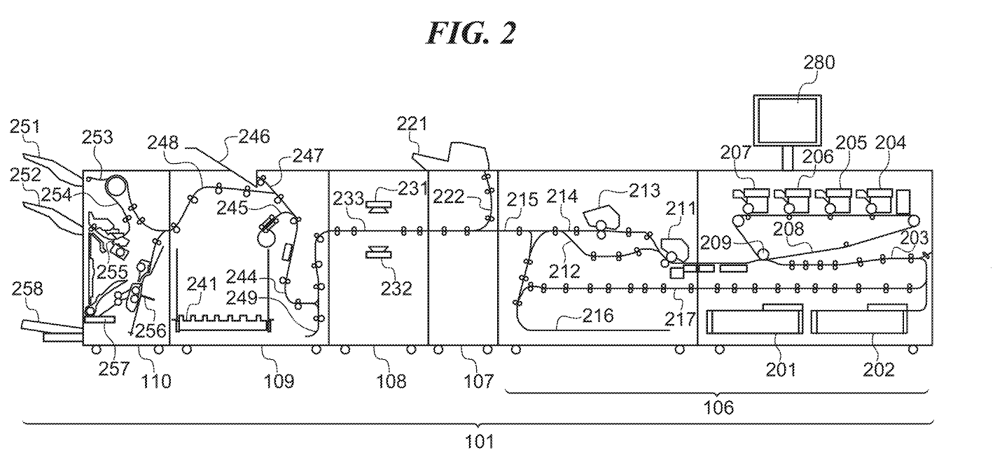

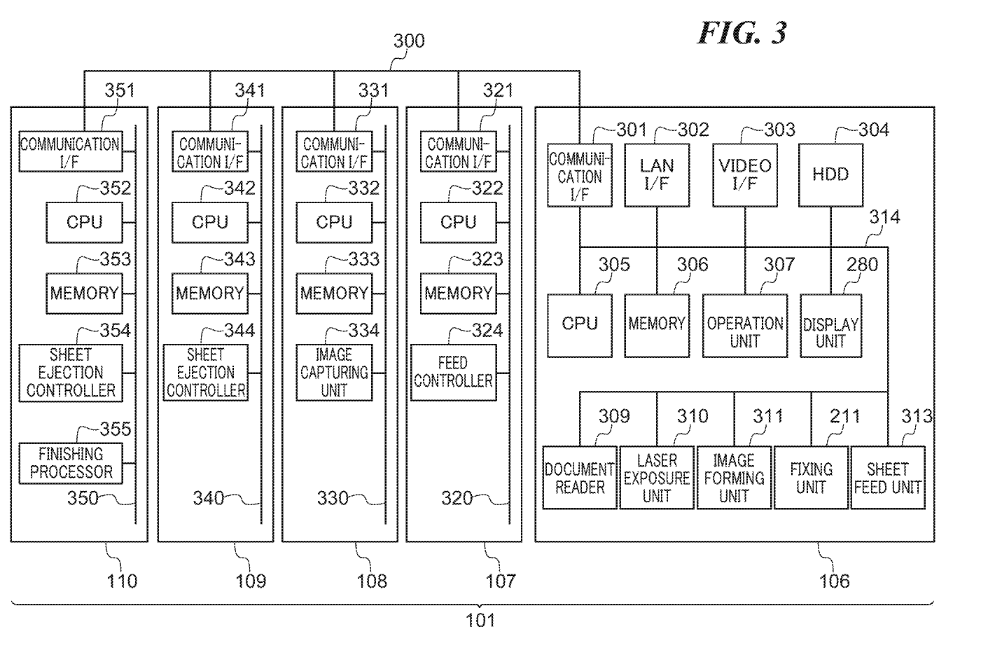

FIG. 2 is a schematic sectional view of the image forming apparatus 101, and FIG. 3 is a block diagram illustrating a hardware configuration of an electric system of the image forming apparatus 101. The image forming apparatus 101 is constituted by connecting a plurality of apparatuses having different functions so as to be capable of performing a complicated print process. That is, the image forming apparatus 101 generates the printed matter by executing a plurality of processes including the image forming process according to the given print job.

A printer 106 forms a print image on a sheet. The printer 106 forms an image on a sheet conveyed from a sheet feeding deck 201 or 202 at the lower right in FIG. 2 by using toner. Although a paper sheet is used as an example in the description, another print medium may be used. The sheet feeding decks 201 and 202 can hold various types of sheets. A user can check information (a sheet size, a sheet type, and the like) about the sheets held in the sheet feeding decks 201 and 202 on a display unit 280 at the upper right in FIG. 2 and can select one of the sheet feeding decks 201 and 202 to be used with an operation unit 307. The user can instruct to execute or cancel a print job and can set various print modes, such as print density, print color, and enlargement/reduction ratio, by operating the operation unit 307.

Each of the sheet feeding decks 201 and 202 separates only the uppermost sheet of the stored sheets and conveys the sheet to a sheet conveyance path 203. Developer stations 204, 205, 206, and 207 form toner images using color toners of yellow (Y), magenta (M), cyan (C), and black (K), respectively. The toner images formed here are primarily transferred to an intermediate transfer belt 208 so as to overlap to form a color image. The intermediate transfer belt 208 rotates clockwise, and the color image is transferred to a sheet conveyed through the sheet conveyance path 203 at a secondary transfer position 209. The display unit 280 displays the print status of the image forming apparatus 101 and information about various settings.

A fixing unit 211 fixes a toner image to a sheet. The fixing unit 211 includes a pressure roller and a heating roller, and fixes the toner image on the sheet by melting and pressing the toner when the sheet passes between the rollers. The sheet having passed through the fixing unit 211 is conveyed to a sheet conveyance path 215 through a sheet conveyance path 212. In a case where a sheet type requires further melting and pressing for fixing, the sheet passed through the fixing unit 211 is then conveyed to a second fixing unit 213 through a sheet conveyance path 214.

The sheet that is additionally melted and pressed in the second fixing unit 213 is then conveyed to the sheet conveyance path 215 through the sheet conveyance path 214. In a double-sided image forming mode, a sheet is conveyed to a sheet reversing path 216 and is reversed in the sheet reversing path 216. Then, the reversed sheet is conveyed to the sheet conveyance path 203 through a double-sided conveyance path 217. And an image is transferred onto a second surface of the sheet at the secondary transfer position 209.

An inserter 107 can insert an insertion sheet at an arbitrary position of a sheet bundle printed and conveyed by the printer 106. The inserter 107 includes an inserter tray 221 and merges a sheet fed on the inserter tray 221 into the sheet conveyance path 215 through a sheet conveyance path 222. This enables to insert a sheet at an arbitrary position of a series of sheets conveyed from the printer 106 and convey the sheets to a succeeding apparatus. The sheet that has passed through the inserter 107 is conveyed to an inspection device 108.

The inspection device 108 reads an image of a printed and conveyed sheet (printed matter), compares the read image with an image to be printed (reference image), inspects whether printing has been executed without any abnormality, and outputs an inspection result. As shown in FIG. 2, cameras 231 and 232 are arranged so as to face each other in the inspection device 108. The camera 231 reads an upper surface of the sheet, and the camera 232 reads a lower surface of the sheet.

The inspection device 108 reads images of the sheet with the cameras 231 and 232 at a timing when the sheet conveyed through the sheet conveyance path 233 reaches a predetermined position, and inspects whether the images printed by the printer 106 is normal. The printed matter determined to have a problem as a result of the inspection is discharged separately from the normal printed matter.

A large-capacity stacker 109 is capable of stacking a large volume of sheets. The large-capacity stacker 109 includes a stack tray 241 on which sheets determined to be normal sheets (printed matter) are stacked. The sheets having passed through the inspection device 108 are stacked on the large-capacity stacker 109 through a sheet conveyance path 244. The sheet is stacked on the stack tray 241 through the sheet conveyance path 244 and a sheet conveyance path 245.

The large-capacity stacker 109 further includes an escape tray 246 as an ejection tray. The printed matter determined to be a rejected product as a result of the inspection by the inspection device 108 is conveyed from the sheet conveyance path 244 and is ejected to the escape tray 246 through a sheet conveyance path 247.

When a sheet is conveyed to a post-processing apparatus in a stage subsequent to the large-capacity stacker 109, the sheet is conveyed through a sheet conveyance path 248. The large-capacity stacker 109 includes a reversing unit 249 that reverses a sheet. The reversing unit 249 is used when stacking the sheet on the stack tray 241. When the sheet is stacked on the stack tray 241, the sheet is reversed once by the reversing unit 249 so as to match the direction of the sheet in outputting to the direction of the sheet in inputting. On the other hand, when conveying the sheet to the escape tray 246 or a subsequent post-processing apparatus, the sheet is discharged as-is without flipping in stacking, and therefore, the reversing operation with the reversing unit 249 is not performed.

The finisher 110 performs a finishing process on a conveyed sheet according to the setting designated by the user. Specifically, the finisher 110 performs the finishing process, such as stapling (one-point stapling/two-point stapling, etc.), punching (two holes/three holes, etc.), or saddle stitch binding. The finisher 110 includes sheet ejection trays 251 and 252. The sheet is output to the sheet ejection tray 251 through a sheet conveyance path 253. However, the finishing process such as stapling cannot be performed in the sheet conveyance path 253.

In a case where the finishing process such as stapling is performed, the sheet is conveyed via a sheet conveyance path 254, subjected to a finishing function designated by the user with a processor 255, and output to the sheet ejection tray 252. The sheet ejection trays 251 and 252 can rise and lower. And it is also possible to lower the sheet ejection tray 251 and stack the sheet subjected to the finishing process with the processor 255 on the sheet ejection tray 251.

When the saddle stitch binding is designated, a saddle stitching unit 256 performs a stapling process on a center of a sheet bundle, folds the sheet bundle in half, and outputs the folded sheet bundle to a saddle stitch binding tray 258 via a sheet conveyance path 257. The saddle stitch binding tray 258 has a belt conveyer, and the saddle stitch bound sheet bundle stacked on the saddle stitch binding tray 258 is conveyed to the left side in FIG. 2.

As shown in FIG. 3, the printer 106 includes a communication I/F 301, a LAN I/F 302, a video I/F 303, an HDD 304, a CPU 305, a memory 306, the operation unit 307, and the display unit 280. The respective components are connected via a system bus 314 so as to mutually communicate required information. The communication I/F 301 is an interface that is connected to other apparatuses via the communication cable 300 and communicates the required information in controlling. The CPU 305 controls the printing operation by executing a control program stored in the memory 306.

The LAN I/F 302 is an interface to communicably connect the printer 106 to an apparatus outside the image forming apparatus 101 via the network 100 etc. The video I/F 303 is an interface to communicating a video signal when, for example, an additional display unit is provided. The HDD 304 stores various information necessary for the present disclosure in a nonvolatile manner. The operation unit 307 is operated by the user to perform required print setting. The display unit 280 displays various information about printing. Further, the display unit 280 may be a touch panel display that also serves as the operation unit 307.

The system bus 314 is connected to a document reader 309, a laser exposure unit 310, an image forming unit 311, the fixing unit 211, and a sheet feed unit 313 so as to be able to communicate required information with the CPU 305. The operations of these components are controlled by the CPU 305. In a copying process, the document reader 309 reads an image of a document, the laser exposure unit 310 and the image forming unit 311 form an image (image formation) on a sheet fed from the sheet feed unit 313 according to the read image, and the fixing unit 211 fixes the formed image.

As shown in FIG. 3, the inserter 107 has a communication I/F 321, a CPU 322, a memory 323, and a feed controller 324, and the respective components are connected via a system bus 320 so as to mutually communicate required information. The communication I/F 321 is an interface that is connected to the printer 106 via the communication cable 300 and communicates required information in controlling. The CPU 322 executes a control program stored in the memory 323 to control the feed controller 324 to insert an insertion sheet.

As shown in FIG. 3, the inspection device 108 has a communication I/F 331, a CPU 332, a memory 333, and an image capturing unit 334, and the respective components are connected via a system bus 330 so as to mutually communicate required information. The communication I/F 331 is an interface that is connected to the printer 106 via the communication cable 300 and communicates required information in controlling. The CPU 332 executes a control program stored in the memory 333 to execute various types of control and processes necessary for inspection.

The memory 333 stores the control program and the like. The inspection device 108 can also receive information from a server, a PC, or the like, which has instructed execution of printing, via a LAN I/F (not shown) and can store the received information to the memory 333. The image capturing unit 334 includes the cameras 231 and 232 and captures images of a conveyed sheet based on an instruction from the CPU 332. The CPU 332 inspects the printed matter by analyzing the images captured with the image capturing unit 334. The CPU 332 may store the history of the execution result of the inspection and the setting contents in the memory 333. And the CPU 332 may read the reference image from the memory 333 to use for the inspection when detecting a screen operation or reading the setting.

As shown in FIG. 3, the large-capacity stacker 109 has a communication I/F 341, a CPU 342, a memory 343, and a sheet ejection controller 344, and the respective components are connected via a system bus 340 so as to be mutually communicate required information. The communication I/F 341 is an interface that is connected to the printer 106 via the communication cable 300 and communicates required information in controlling. The CPU 342 executes a control program stored in the memory 343 to control the sheet ejection controller 344 and the like, thereby performing various controls necessary for stacking a large volume of sheets.

As shown in FIG. 3, the finisher 110 has a communication I/F 351, a CPU 352, a memory 353, a sheet ejection controller 354, and a finishing processor 355, and the respective components are connected via A system bus 350 so as to mutually communicate required information. The communication I/F 351 is an interface that is connected to the printer 106 via the communication cable 300 and communicates required information in controlling. The CPU 352 executes a control program stored in the memory 353 to perform sheet ejection control for controlling the sheet ejection controller 354 and various finishing processes.

In the embodiment according to the present disclosure, a predictive calculation that estimates a processing time based on job information and calculates CO2 emissions based on the estimated processing time and power consumption (W/h) for each process of each apparatus determined in advance is taken as an example. On the other hand, a method based on an actual measurement calculation that measures an actual processing time instead of the estimated processing time and calculate CO2 emissions using the actual processing time and the power consumption (W/h) for each process of each apparatus determined in advance may be employed. Alternatively, the calculation may be performed by a method of directly monitoring the power consumption by mounting a power measuring unit on each apparatus.

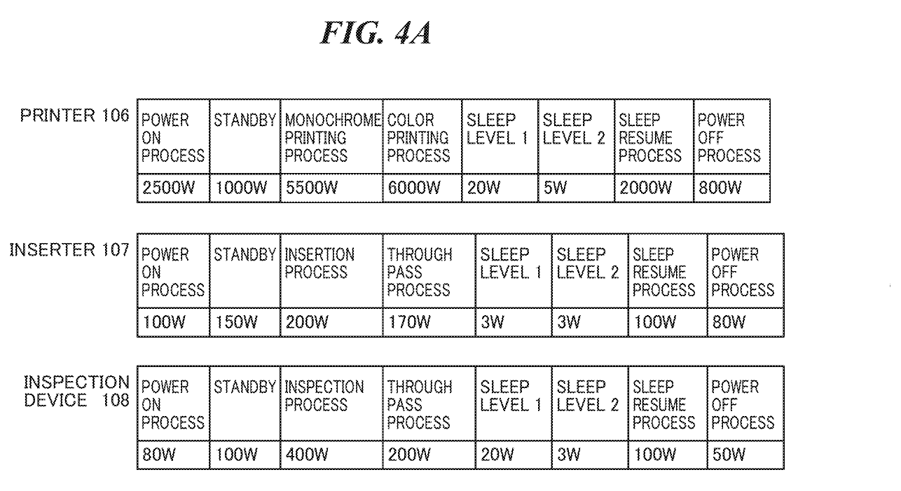

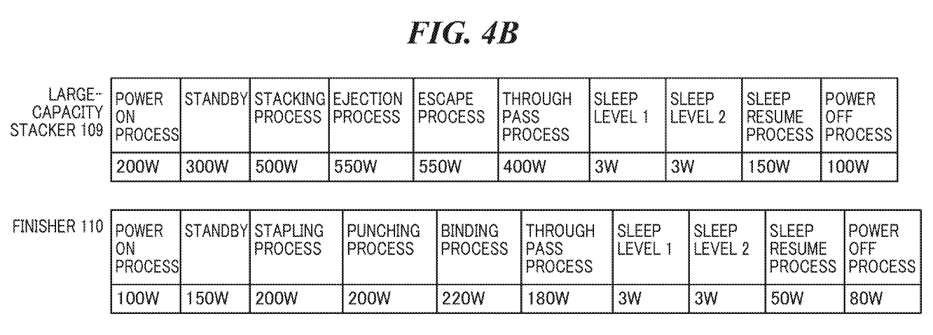

FIG. 4A and FIG. 4B are explanatory diagrams of tables that define power consumptions of the apparatuses included in the image forming apparatus 101. These tables are stored in the HDD 304 in the nonvolatile manner, for example. These tables define power consumptions in a power ON process, standby, a sleep level 1, a sleep level 2, a sleep resume process, and a power OFF process in common in the respective apparatuses. The sleep levels 1 and 2 represent stages of a sleep state (power saving state), respectively. The power consumption of the sleep level 1 in which the power consumption is large but the sleep resume time is short and the power consumption of the sleep level 2 in which the power consumption is small but the sleep resume time is long are defined.

Power consumption of a through pass process in which a sheet is directly passed to a subsequent stage without performing any process in the apparatus is defined for each of the apparatuses except for the printer 106. In addition, power consumptions of a monochrome printing process, an inspection process, a stacking process, a stapling process, and the like, which are unique to the specific apparatuses, are defined. Note that the table set shown in FIG. 4A and FIG. 4B is an example defining the power consumptions. Since the power supply voltage and current vary from country to country, it is desirable to prepare a plurality of table sets in consideration of these circumstances and to make the table sets switchable. These power consumptions can be converted into CO2 emissions.

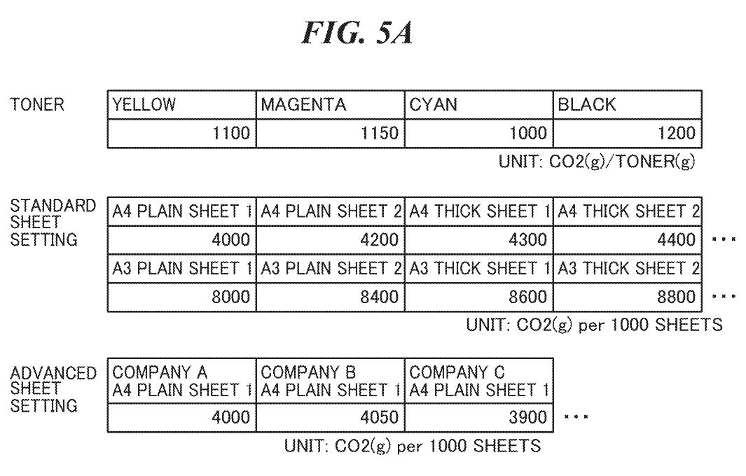

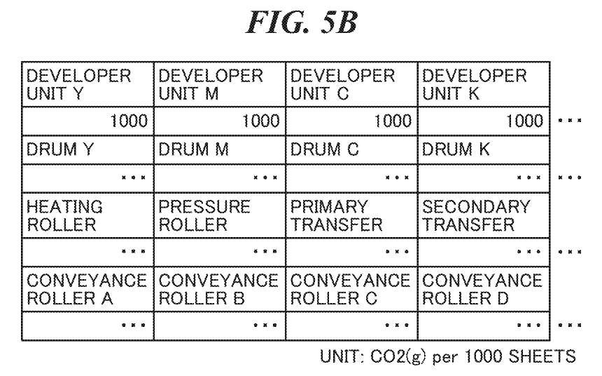

The CO2 emissions vary depending on a print product, and particularly depend on usage amounts of toner and sheets. FIG. 5A shows an example of a table set used to calculate CO2 emissions from the usage amounts. These tables are stored in the HDD 304 in the nonvolatile manner, for example. There are a plurality of known methods for calculating a toner consumption amount. The embodiment according to the present disclosure employs a method of calculating the toner consumption amounts from signal values in forming a color image in the developer stations 204 to 207 (see FIG. 2) and converting the calculated toner consumption amounts into CO2 emissions according to the upper table in FIG. 5A.

As for a standard sheet, a method is employed in which the sizes and types of the standard sheets stored in the sheet feeding decks 201 and 202 and set with the operation unit 307 are associated with the middle table in FIG. 5A, and which sheet is used is specified and converted into CO2 emissions. At this time, when the CO2 emissions of specific sheet media are stored (held) as shown in the lower table in FIG. 5A in addition to the CO2 emissions of the standard sheets, the CO2 emissions can be calculated in more detail. Further, the CO2 emissions of the specific sheet media can be stored in advance in the HDD 304 of the image forming apparatus 101 and can be added/edited by the user.

FIG. 5B illustrates a part of a table indicating CO2 emissions for each consumable part. These tables are stored in the HDD 304 in the nonvolatile manner, for example. Since the parts are consumed each time image formation is performed, an appropriate action such as replacement is required at a certain timing. The CO2 emissions per page is calculated from the maximum print volume until replacement. The table in FIG. 5B defines CO2 emissions (g) per 1000 sheets of developer units (Y, M, C, and K), drums (Y, M, C, and K), heating roller, pressure roller, primary transfer, secondary transfer, conveying rollers (A to D), and the like. Although the CO2 emissions for each consumable part are prepared as the table in the embodiment according to the present disclosure in order to enable detailed calculation, the CO2 emissions may be calculated using CO2 emissions of collected multiple parts per one page or multiple unit pages.

As described above, CO2 emits by the power consumption indicated in FIGS. 4A and 4B, and also CO2 emit by the consumable parts indicated by FIGS. 5A and 5B. The CPU 305 calculates the CO2 emissions generated in the image forming apparatus 101 based on the power consumption of the processes and the CO2 emissions of the consumable parts in the image forming apparatus 101. Further, for example, the CO2 emissions can be obtained by multiplying the power consumption by a predetermined coefficient.

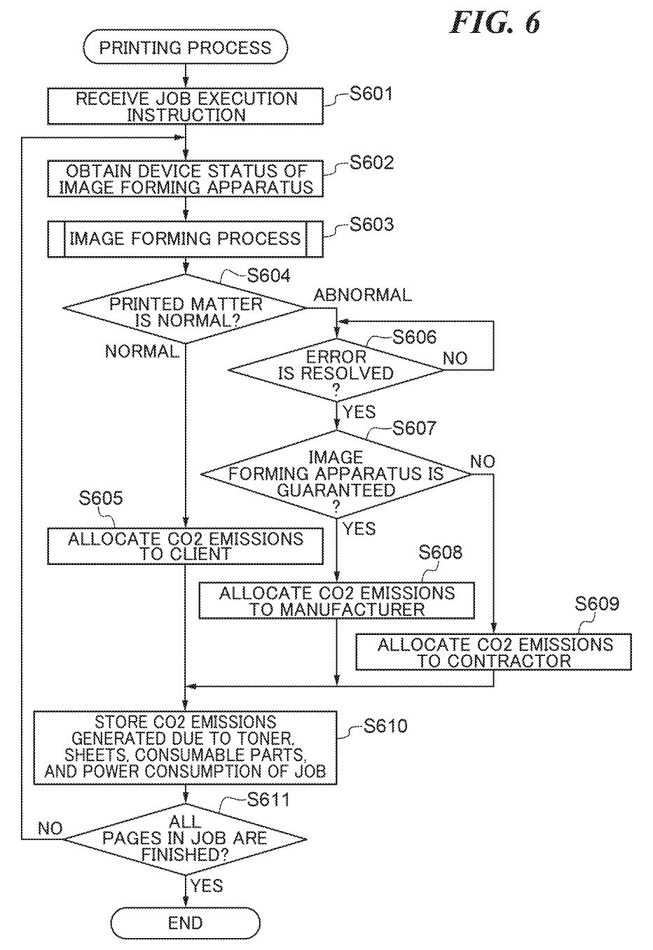

Next, a first embodiment will be described. FIG. 6 is a flowchart illustrating a printing process including a calculation process and an allocation process to calculate and allocate CO2 emissions of the printer 106 related to the first embodiment. The series of steps in the flowchart are executed by the CPU 305 of the printer 106. The process in the printer 106 is achieved by the CPU 305 loading the control program read from the HDD 304 into the memory 306 and executing the control program.

First, the CPU 305 receives a job execution instruction in a step S601 and proceeds with the process to a step S602. Next, the CPU 305 obtains a device status of the image forming apparatus 101 in the step S602. That is, the CPU 305 obtains device information and intra-device part information about the image forming apparatus 101 from the HDD 304. The device information is information about a state of the image forming apparatus 101 itself, and the intra-device part information is information about the consumable parts. An example of the device information is a product guarantee period of the image forming apparatus 101 itself. Example of the intra-device part information are a life of a consumable part used in the image forming apparatus 101, toner cartridge information, and the like. In addition, the CPU 305 determines whether a consumable part mounted on the image forming apparatus 101 is a guarantee target (in other words, whether the consumable part is within a guarantee period), and holds a determination result as a CO2 emission guaranteed determination result in the HDD 304.

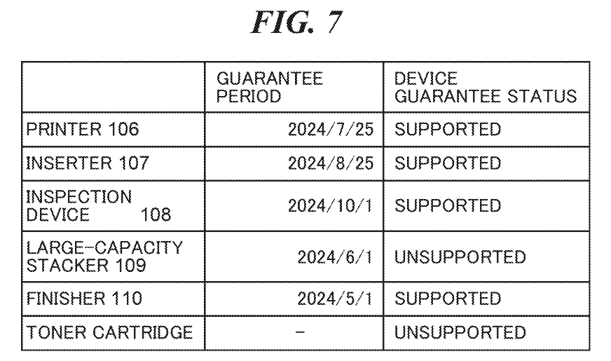

Here, the CO2 emission guarantee determination result will be described. FIG. 7 indicates a CO2 emission guarantee determination item, a guarantee period, and a device guarantee status in association with each other. The information shown in FIG. 7 is generally referred to as guarantee information. A guarantee period (expiration date) is set for each of the devices (from the printer 106 to the finisher 110) of the image forming apparatus 101. When the current time is within the guarantee period, the device guarantee status becomes “supported”, and otherwise, the device guarantee status becomes “unsupported”. The CO2 emission guarantee determination items shown in FIG. 7 are examples, and the number of CO2 emission guarantee determination items may be increased or decreased for each product. In addition, although FIG. 7 indicates a case where different guarantee periods are set for the respective devices, the same guarantee period may be set for a plurality of devices.

Next, the CPU 305 executes an image forming process in a step S603. Next, the CPU 305 determines whether printed matter output is normal in a step S604. When the CPU 305 determines that the printed matter output is normal, the process proceeds to a step S605. On the other hand, when the CPU 305 determines that the printed matter output is not normal (is abnormal), the process proceeds to a step S606.

In the step S605, the CPU 305 sets the account for the CO2 emissions to the client. Next, in a step S610, the CPU 305 calculates the CO2 emissions generated due to the toner/sheets/consumable parts used for the image formation and the power consumption of the job based on the information obtained in the step S602 and stores the CO2 emissions in the HDD 304. Then, in a step S611, the CPU 305 determines whether all pages in the job are finished. When it is determined that all the pages are finished (Yes), the printing process is terminated. Whereas when it is determined that all the pages are not finished (No), the process is repeated from the step S602.

On the other hand, in the step S604, when the CPU 305 determines that the printed matter output is not normal (is abnormal), in other words, when the CPU 305 determines that some abnormality occurs, the CPU 305 interrupts the job. In the step S606, the CPU 305 determines whether the error has been resolved by the user. When the CPU 305 detects that the error has been resolved by the user (Yes), the process proceeds to a step S607. When the resolution is not detected (No), the process waits in the step S606. The error is a paper jam or the like.

Next, in the step S607, the CPU 305 determines whether the image forming apparatus 101 is guaranteed based on the guarantee information about the image forming apparatus 101. Then, when determining that the guarantee of the image forming apparatus 101 is guaranteed (YES) based on the guarantee determination result described above, the CPU 305 sets the account for the CO2 emissions to the “manufacturer” in a step S608. On the other hand, when determining that the guarantee of the image forming apparatus 101 is not guaranteed (NO), the CPU 305 sets the account for the CO2 emissions to the “contractor” in a step S609.

When the process proceeds through the step S608 or S609, the CPU 305 calculates CO2 emissions generated due to the toner/sheets/consumable parts used for the abnormal image formation and the power consumption of the job and stores the CO2 emissions in the HDD 304 in the step S610. Then, the CPU 305 restart the image forming process. After restarting the image forming process, the CPU 305 proceeds with the process to the step S611 and determines whether to finish the printing process. The user may change and set the account and the allocation ratio of the CO2 emissions according to contents of a print request contract.

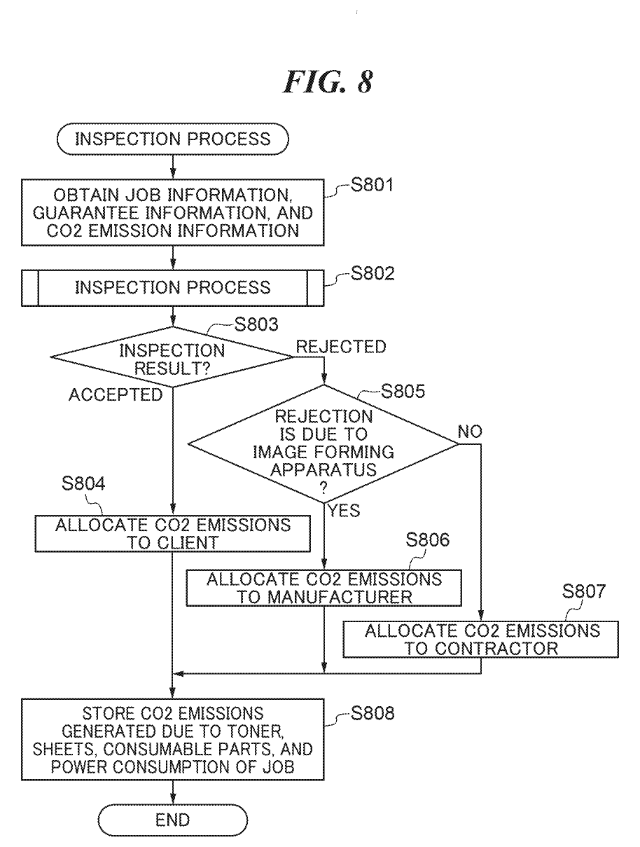

Next, a second embodiment will be described. The image forming apparatus 101 is equipped with the inspection device 108 as shown in FIG. 3, and can inspect the quality of the normally output printed matter. Therefore, it is possible to calculate CO2 emissions and select the account according to the inspection result. The second embodiment is characterized in that the calculation of the CO2 emissions is performed by using the inspection result by the inspection device 108 mounted on the image forming apparatus to select the account. FIG. 8 is a flowchart illustrating an inspection process including a calculation process and an allocation process of CO2 emissions in the image forming apparatus 101 related to the second embodiment in which the inspection device 108 is mounted and an inspection result can be used.

The inspection device 108 receives an inspection instruction from the CPU 305 after the image forming process in the image forming apparatus 101. When the inspection device 108 receives the inspection instruction, the CPU 305 obtains the job information, the CO2 emission information in printing, and the guarantee determination result of the printer 106 described in the first embodiment. These are obtained by the process in the steps S601 to S607 in FIG. 6.

Next, in a step S802, the CPU 332 of the inspection device 108 executes the following inspection process. That is, when the printed matter is conveyed to a predetermined position through the sheet conveyance path 233, the CPU 332 reads the images on the upper and lower surfaces of the sheet with the cameras 231 and 232. Then, the CPU 332 compares the images of the upper and lower surfaces with master images set in advance and inspects whether the printed matter by the printer 106 is normal. Next, the CPU 332 determines the inspection result in a step S803. Then, the CPU 332 separates and discharges printed matter determined as a rejected product (rejected) having a problem in the inspection result from normal printed matter (an accepted product).

When determining that the printed matter is an accepted product (accepted) in the step S803, the CPU 332 proceeds with the process to a step S804 and sets the account for the CO2 emissions to the client. On the other hand, when determining that the printed matter is a rejected product (rejected) in the step S803, the CPU 332 proceeds with the process to a step S805. Note that the CPU 332 can notify the CPU 305 of the inspection result in the step S803 via the communication cable 300. In such a case, the CPU 305 notified of the inspection result can execute the process from the step S804. In the present embodiment, the CPU 332 executes the process from the step S804.

In the step S805, the CPU 332 determines whether the rejection (inspection failure) is due to the image forming apparatus 101. When it is determined that the rejection is due to the image forming apparatus (YES), the process proceeds to a step S806, and when it is determined that the rejection is due to other than the image forming apparatus (NO), the process proceeds to a step S807. Since the reason of the rejection in the result is shown, the CPU 332 switches the account for the CO2 emissions depending on whether the rejection is caused by the apparatus or the manufacturer for each item of the rejection. That is, when determining that the rejection is due to the apparatus (YES), the CPU 332 sets the manufacturer of the image forming apparatus 101 as the account for the CO2 emissions in the step S806. On the other hand, when determining that the rejection is due to other than the apparatus (NO), the CPU 332 sets the print contractor as the account for the CO2 emissions in the step S807.

Then, in a step S808, the CPU 305 calculates the CO2 emissions generated due to the toner/sheets/consumable parts and the power consumption of the job based on the information obtained in the step S801 and stores the CO2 emissions in the HDD 304. The inspection function allows to prepare inspection levels, and the print contractor mainly sets an inspection level according to its own regulation. In this case, when printed matter is rejected in the inspection of which the level is higher than the level set by the manufacturer, the CO2 emissions for the printed matter may be allocated to the print contractor. That is, as a result of the inspection by the inspection device 108, when a quality of printed matter is equal to or higher than a specified level set by the manufacturer, it may be determined that the printed matter is an accepted product, and when the quality of the printed matter is lower than the specified level, it may be determined that the printed matter is a rejected product, and the CPU 305 may execute the following process. When the inspection device 108 determines that the printed matter is a rejected product, the CPU 305 sets the account for the CO2 emissions for the rejected product to the print contractor. In addition, when the inspection device 108 determines that the printed matter is a rejected product, the CPU 305 may select the account for the CO2 emissions due to reprinting between the print contractor and the manufacturer according to the cause of the rejection.

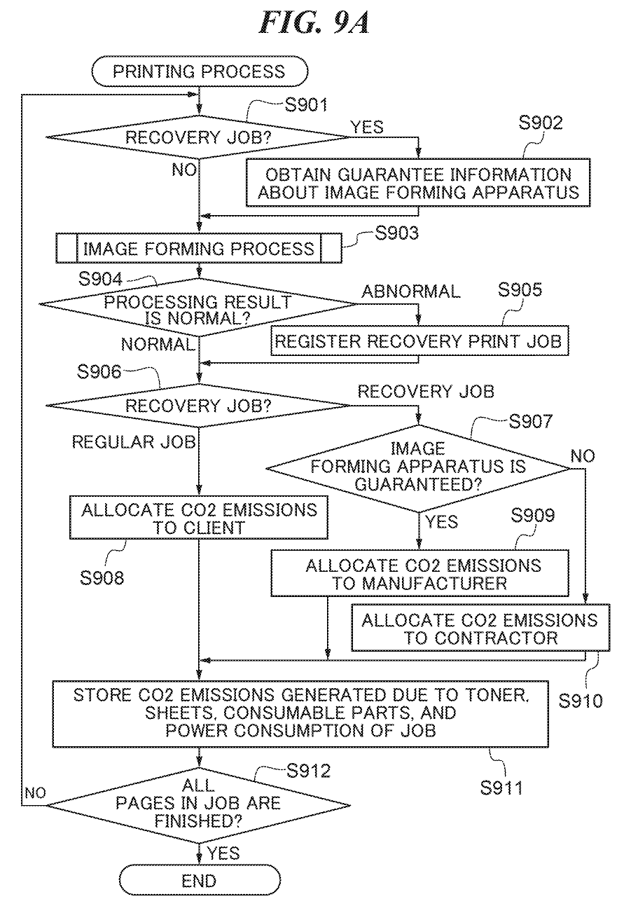

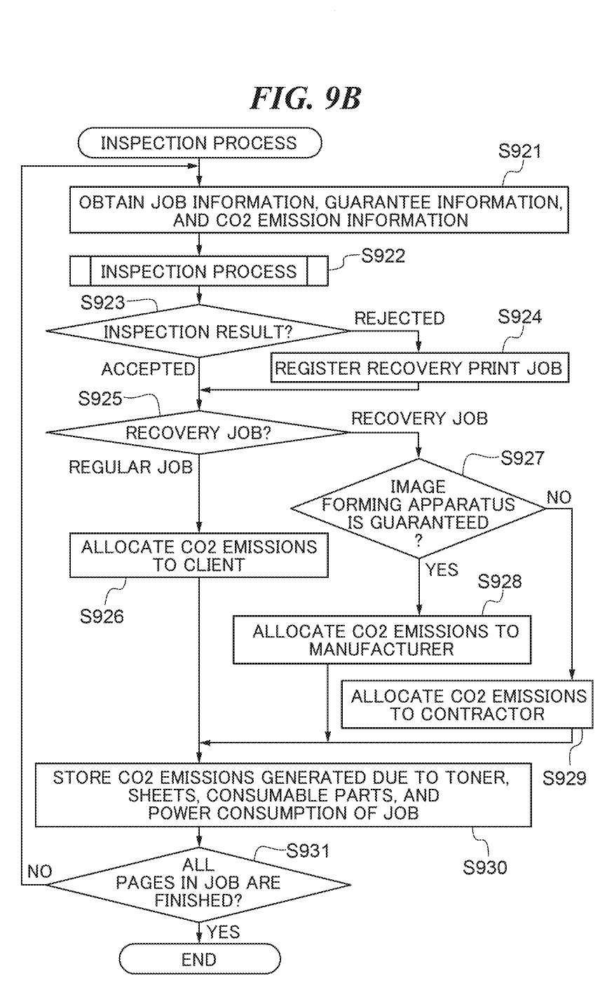

The first and second embodiments set the account for the CO2 emissions generated in the job in executing. In the meantime, the image forming apparatus 101 is able to have a recovery printing function of automatically storing the information about the job in the memory 306 and registering a recovery job when a printing abnormality occurs or when the inspection result is “rejected” as illustrated in FIGS. 9A and 9B. In this case, the CO2 emissions generated in the job in executing may be allocated to the client, and the account for the CO2 emissions generated in executing the recovery job may be selected from the apparatus manufacturer or the print contractor on the basis of the guarantee determination result (guarantee information). Hereinafter, a process in the image forming apparatus 101 capable of executing a recovery job will be described briefly with reference to FIGS. 9A and 9B.

The latter half of the process in FIG. 9A is basically the same as the latter half of the process in FIG. 6. First, the CPU 305 determines whether a given job is a recovery job in a step S901. When it is determined that the job is a recovery job (YES), the process proceeds to a step S902. When it is determined that the job is not a recovery job (NO), the process proceeds to a step S903. The CPU 305 obtains the guaranteed information about the image forming apparatus 101 in the step S902, and proceeds with the process to the step 903. Next, the CPU 305 executes the image forming process according to the print job in the step S903, and proceeds with the process to a step S904.

Next, the CPU 305 determines whether the processing result is normal in the step S904. When it is determined that the processing result is normal, the process proceeds to a step S906. On the other hand, when it is determined that the processing result is abnormal, the CPU 305 registers a recovery print job in the memory 306 in a step S905, and the process proceeds to a step S906. Next, the CPU 305 determines whether the print job is a recovery job in the step S906. When it is determined that the print job is a recovery job, the process proceeds to a step S907, whereas when it is determined that the print job is a regular job, the process proceeds to a step S908. The subsequent steps S907 to S912 are respectively equivalent to the steps S607, S605, S608, S609, S610, and S611 in FIG. 6.

The process in FIG. 9B is basically the same as the inspection process in FIG. 8, and steps S924 and S925, which are related to the recovery job, are added, and therefore only these steps will be described. The CPU 305 is notified of the information indicating an inspection result and determines whether the result is “accepted” or “rejected” in a step S923. In the following description, the CPU 305 shall execute the process. When the inspection result is “rejected”, the CPU 305 registers the recovery job in the memory 306 in the step S924 and proceeds with the process to a step S925.

Next, the CPU 305 determines whether the print job is a recovery job in the step S925. When it is determined that the print job is a recovery job, the process proceeds to a step S927. On the other hand, when the CPU 305 determines that the is a regular job, the process proceeds to a step S926.

Then, the CPU 305 determines whether the image forming apparatus 101 is guaranteed based on the guaranteed determination result in the step S927. When the CPU 305 determines to be guaranteed (YES), the process proceeds to a step S928. When the CPU 305 determines not to be guaranteed (NO), the process proceeds to a step S929. A step S931 is the same as the step S611.

As described above, when a printing abnormality occurs or when the inspection result is “rejected”, the CPU 305 automatically stores the information about the job in the memory 306 and registers the recovery job as shown in FIGS. 9A and 9B. As a result, the CPU 305 allocates the CO2 emissions generated in the job in executing to the client, and selects the account for the CO2 emissions generated in executing the recovery job from the apparatus manufacturer or the print contractor on the basis of the guarantee determination result of the image forming apparatus 101.

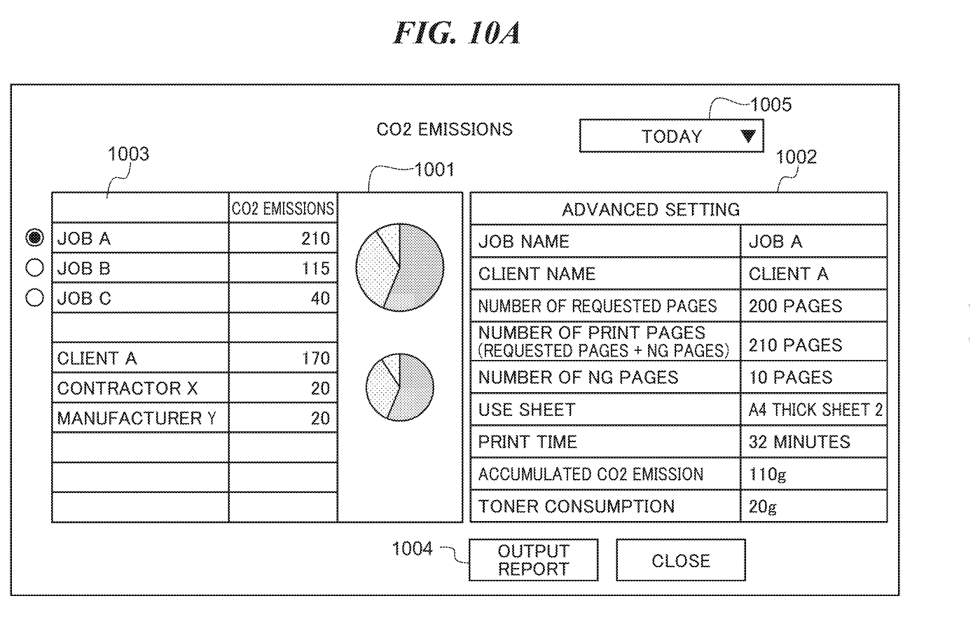

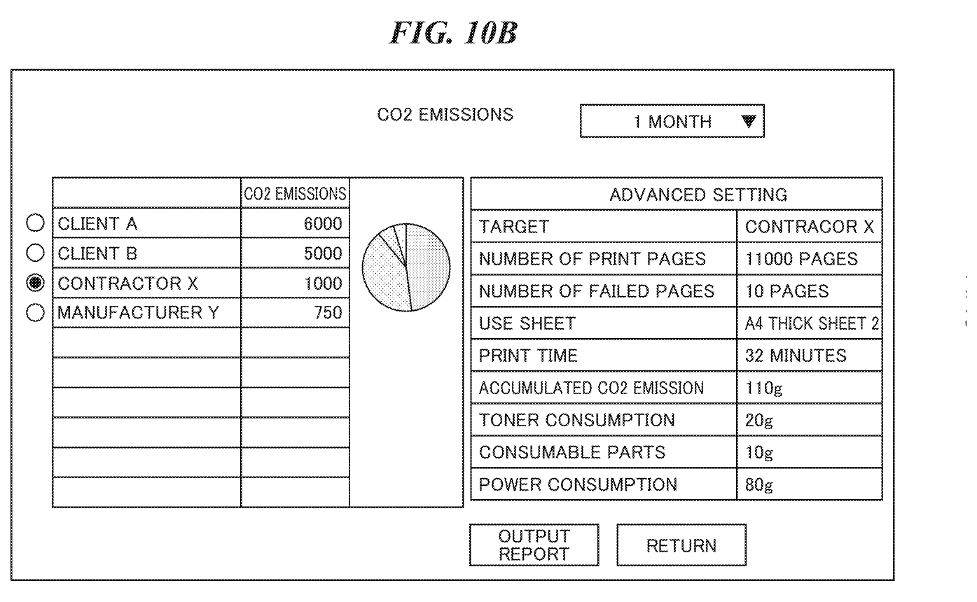

FIGS. 10A and 10B are views illustrating examples of screens showing operation statuses and CO2 emissions displayed on the display unit 280. These screens are displayed by the CPU 305 with reference to the tables indicating the CO2 emissions of the toner/sheets/consumable parts described with reference to FIGS. 4A, 4B, 5A and 5B.

FIG. 10A is an example of a CO2 emission display screen. In the present embodiment, the CO2 emissions generated due to the toner/sheets/consumable parts/power consumption of a job are calculated for each job allocated to the account selected in the first and second embodiments and are displayed in a table 1001. A table 1002 indicates advanced settings for each item. Further, a job can be selected and switched by a selection operation of a button in a column 1003. In the example in FIG. 10A, a job A is selected, and the CO2 emissions for the job A is displayed as “210”. In addition, the client company (client) A, the printing company (contractor) X, and the apparatus manufacturing company (manufacturer) Y are displayed in the table 1001 as the accounts, and the CO2 emissions for each account are also displayed for each job.

Further, the displayed contents can be printed by pressing a report output button 1004. Although the display on the display unit 280 and the printout are described in this example, the CPU 305 may transmit the operation status and the information about the CO2 emissions as the electronic data to a transmission destination apparatus, such as a print server (not shown) or the environmental load calculation server, via the LAN I/F 302.

The calculation period of the CO2 emissions can be switched according to a switching operation of a pull-down menu 1005 in FIG. 10A. Since the meaning of job-basis display is weakened in a long period such as one month, the jobs are integrated and the total sum of the CO2 emissions within a predetermined period (one month) for the respective accounts are displayed on the screen in FIG. 10B. Specifically, the accounts (a client A, a client B, a contractor X, and a manufacturer Y) and the respective CO2 emissions are displayed in association with each other. In the case of FIG. 10B, the account is also selectable by a selection operation of a button. In the display example in FIG. 10B, the contractor X is selected and the state is displayed, and the corresponding CO2 emissions “1000” for “one month” and the details (breakdown) thereof are displayed.

As described above, since the CO2 emissions for each job and the other system discharge amounts are displayed, the CO2 emissions of each of the print contractor and the client of the commercial/industrial printing can be calculated.

Next, a third embodiment will be described. In the first and second embodiments, the example in which the CO2 emissions of the single image forming apparatus 101 are calculated with the printer 106 has been described. On the other hand, many printing companies for commercial/industrial printing use a plurality of image forming apparatuses, an inspection apparatus that inspects printed images, or post-processing apparatuses for bookbinding and surface treatment. Therefore, the third embodiment is characterized in that not only one image forming apparatus 101 but also a plurality of image forming apparatuses 101 and post-processing apparatuses are collectively managed to build a server capable of calculating and displaying CO2 emissions of each apparatus. In the third embodiment, the environmental load calculation server 105 shall be connected to three image forming apparatuses 101, the cutting-and-binding apparatus 103, and the inspection apparatus 104 so as to communicate required information. The inspection apparatus 104 detects whether an operation abnormality has occurred in the cutting-and-binding apparatus 103.

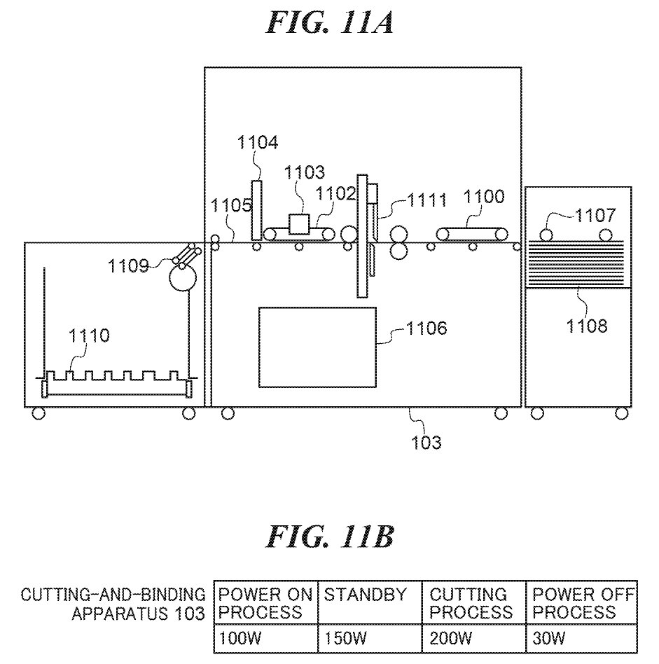

FIG. 11A is a sectional view illustrating the cutting-and-binding apparatus 103 (see FIG. 1). The cutting-and-binding apparatus 103 is a general three-side cutter capable of cutting three sides of a sheet. The cutting-and-binding apparatus 103 cuts sheets by a predetermined length with a cutter unit 1111 and aligns an edge of a bound sheet bundle. A cutting unit, which cuts sheets, of the cutting-and-binding apparatus 103 includes the cutter unit 1111, a press unit 1103 for fixing sheets, an abutting unit 1104, conveyance units 1100, 1102, and 1105, and a disposal box 1106. A sheet feed unit (on the right side in FIG. 11A) includes a sheet feed roller 1107 and a sheet feed tray 1108. A sheet ejection unit (on the left side in FIG. 11A) includes a sheet ejection roller 1109 and a sheet ejection tray 1110.

The cutting operation of the cutting-and-binding apparatus 103 will be described. The uppermost sheet among the sheets stored on the sheet feed tray 1108 is fed with the sheet feed roller 1107, and is conveyed to the cutting position with the conveyance units 1100 and 1102, and then the sheet position is adjusted by the abutting unit 1104. Then, the cutter unit 1111 is lowered to cut the sheet fixed by the press unit 1103. The cut portion generated in the cutting process falls by its own weight and is stored in the disposal box 1106. In addition to the cutter unit 1101, the cutting-and-binding apparatus 103 is provided with two cutter units (not shown) on a near side and a far side facing across the sheet conveyance path so as to be capable of three-side cutting in addition to fore-edge cutting.

The cutter unit 1111 has an adjustment mechanism for the cutting position in the sheet conveyance direction, and the cutting position from the sheet edge can be adjusted. The cutter units on the near side and the far side facing across the sheet conveyance path have an adjustment mechanism of the cutting positions in the width direction, and the cutting positions can be adjusted from the near side of the sheet and the far side of the sheet. The cut sheet is conveyed with the conveyance unit 1105 and is ejected to the upper portion of the sheet ejection tray 1110 by using the sheet ejection roller 1109. Although the cutting operation has been described here by way of an example in which one sheet is conveyed, the cutting may be performed after a plurality of sheets are fed, or the cutting process may be performed by conveying a sheet bundle as a unit.

FIG. 11B is a table representing power consumption for each process in the cutting-and-binding apparatus 103, and the power consumption of the cutting-and-binding apparatus 103 is calculated with reference to this table. In the example shown in FIG. 11B, a power ON process, standby, a cutting process, and a power OFF process are set for cutting-and-binding apparatus 103, and the respective power consumptions are defined as 100W, 150W, 200W, and 30W. This table is stored in, for example, the HDD 304 and can be referred by the CPU 305. When the CPU 305 calculates the power consumption of the cutting-and-binding apparatus 103, the power consumption according to the actually executed process is calculated with reference to this table.

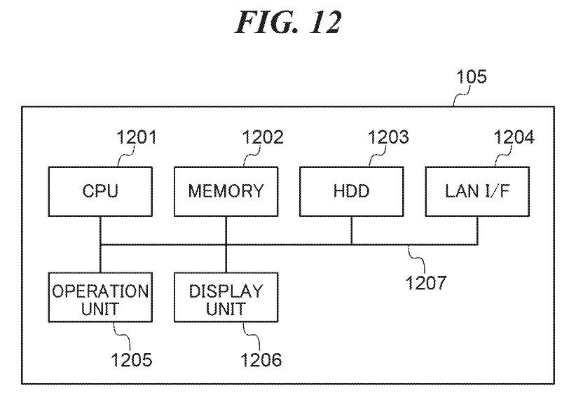

FIG. 12 is a block diagram illustrating a hardware configuration of the environmental load calculation server 105. The environmental load calculation server 105 includes a CPU 1201, a memory 1202, an HDD 1203, a LAN I/F 1204, an operation unit 1205, and a display unit 1206, which are connected to a system bus 1207 so as to mutually communicate required information. The CPU 1201 loads a program and data stored in the HDD 1203 into the memory 1202 and executes the program. Accordingly, the CPU 1201 executes processes, such as reception of the job history information and the operation information from the image forming apparatus 101 and the cutting-and-binding apparatus 103 and calculation of the CO2 emissions.

The memory 1202 stores programs, data, and tables necessary when the CPU 1201 executes various processes, and functions as a work area when the CPU 1201 executes the processes. The HDD 1203 stores various programs, data, and tables necessary for operations. The operation unit 1205 is an input device used to input an operation instruction. The display unit 1206 displays information about an application running on the environmental load calculation server 105 by a still image or a moving image. The LAN I/F 1204 is an interface that is connected to the image forming apparatus 101, the cutting-and-binding apparatus 103, and the like via the network 100 and communicates information such as job history information and operation information.

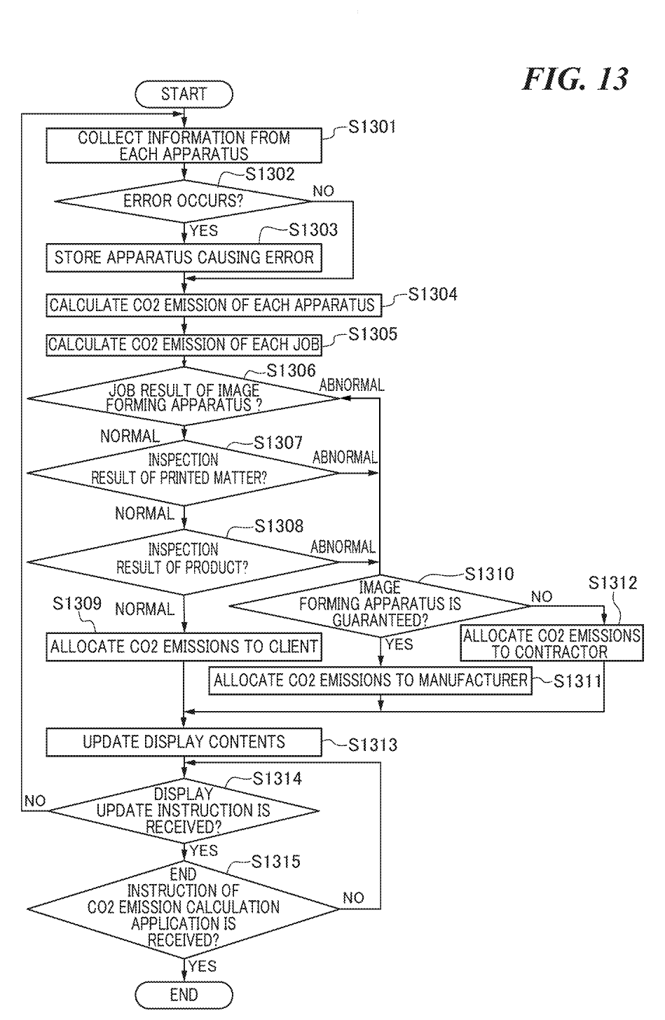

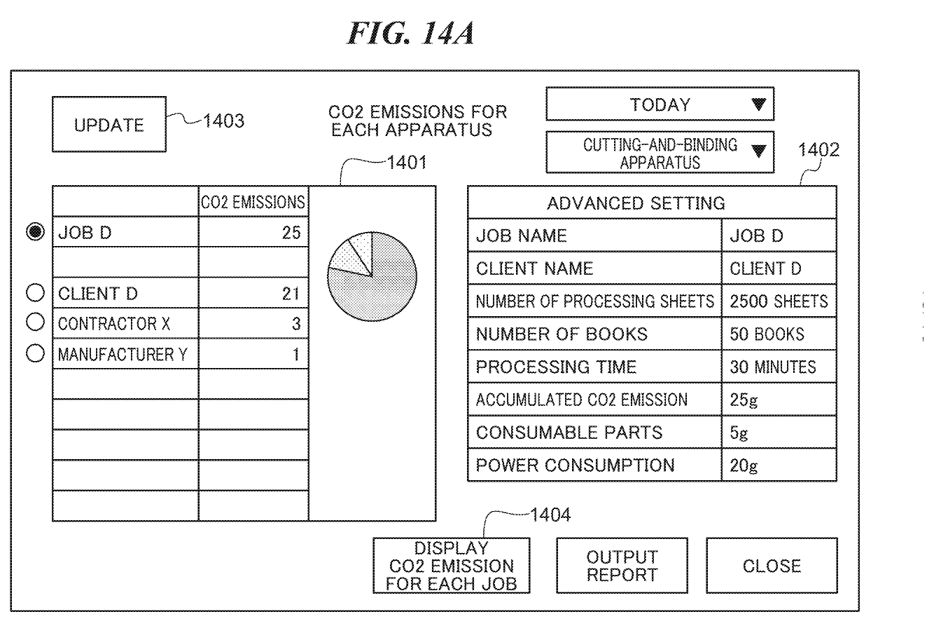

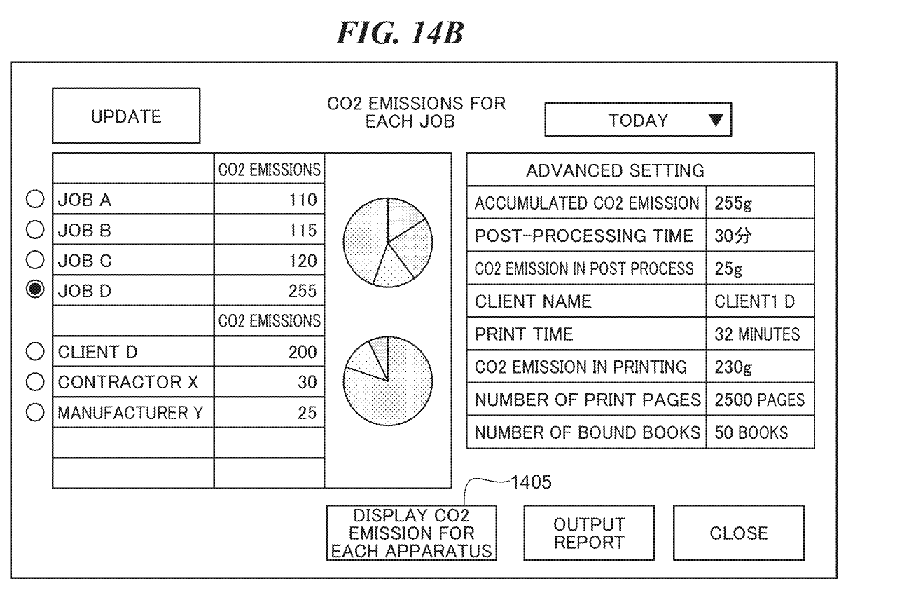

Next, a calculation process and an allocation process to calculate and allocate CO2 emissions executed by the environmental load calculation server 105 will be described with reference to FIGS. 13, 14A and 14B. FIG. 13 is a flowchart illustrating a process executed by the CPU 1201 of the environmental load calculation server 105. FIGS. 14A and 14B are views illustrating examples of display screens of a CO2 emission calculating application displayed on the display unit 1206 of the environmental load calculation server 105.

Instead of displaying the information on the display unit 1206, the application may transmit the information to an information processing apparatus (not illustrated) connected to the network 100 so as to display the information on a display unit of the information processing apparatus.

The process shown in FIG. 13 is started with the execution of the CO2 emission calculating application as a trigger. First, the CPU 1201 collects operation information and job information from the three image forming apparatuses 101 and the cutting-and-binding apparatus 103 in a step S1301. Examples of the operation information are indicated as items of “NUMBER OF PROCESSING SHEETS, POST-PROCESSING TIME, PRINT TIME, NUMBER OF PRINT PAGES, NUMBER OF BOUND BOOKS” in the breakdown information on the right sides in FIGS. 14A and 14B. Next, the CPU 1201 determines in a step S1302 whether an error occurred in collecting the information described above. The error is, for example, a problem occurred in the network communication when the apparatuses are in a power off state. When the CPU 1201 determines that an error occurs (YES), the process proceeds to a step S1303. When the CPU 1201 determines that no error occurs (NO), the process proceeds to a step S1304.

Next, the CPU 1201 stores the information indicating the apparatus in which the error occurs in the HDD 1203 in the step S1303. Next, the CPU 1201 calculates in the step S1304 CO2 emissions (first CO2 emissions) of each apparatus based on the operation information and the job information obtained in the step S1302. The calculation of the CO2 emissions is the same as that in the first embodiment. For example, the CPU 1201 obtains the number of print pages from the operation information and calculates the first CO2 emissions due to various consumable parts (see FIGS. 5A and 5B).

Further, various types of information for calculating the first CO2 emissions of the cutting-and-binding apparatus 103 are stored in the HDD 1203 in the table form as shown in FIGS. 4A, 4B, 5A and 5B. Accordingly, the CPU 1201 calculates the CO2 emissions of the cutting-and-binding apparatus 103 from the operation information and the job information. Since the consumable parts and the execution process of the job are different between the image forming apparatus 101 and the cutting-and-binding apparatus 103, it is necessary to prepare the above tables before executing the process shown in FIG. 13.

Next, the CPU 1201 calculates in a step S1305 CO2 emissions (second CO2 emissions) of each job in each apparatus based on the operation information of each apparatus and the job information. The CPU 1201 calculates the second CO2 emissions using, for example, the above-described predictive calculation.

Next, the CPU 1201 determines in a step S1306 whether the result (job result) of the print job executed by the image forming apparatus 101 is normal. Note that the CPU 1201 determines whether the result is normal or abnormal in the step S1306 depending on the inspection result of the inspection device 108. For example, the process from the step S1306 may be repeatedly executed for each image forming apparatus 101 when the environmental load calculation server 105 is connected to a plurality of image forming apparatuses 101 via the network 100. When the CPU 1201 determines that the result is normal, the process proceeds to the step S1307. When the CPU 1201 determines that the result is abnormal, the process proceeds to a step S1310.

The CPU 1201 determines in the step S1307 whether the inspection result (print inspection result) of the printed matter of the image forming apparatus 101 is normal. When the CPU 1201 determines that the result is normal, the process proceeds to the step S1308. When the CPU 1201 determines that the result is abnormal, the process proceeds to the step S1310. When the CPU 1201 (determination unit) determines that the result is abnormal or normal in each of the steps S1306 and S1307, it is determined whether a printing abnormality occurs in each of the three image forming apparatuses 101. Further, the process may be executed for the cutting-and-binding apparatus 103 by skipping steps S1306 and S1307.

Next, the CPU 1201 (a determination unit) determines in the step S1308 whether the cutting-and-binding apparatus 103 is abnormal or normal based on the inspection result of the inspection apparatus 104. More specifically, the CPU 1201 determines whether an operation abnormality occurs in the cutting-and-binding apparatus 103 by the inspection apparatus 104 inspecting the product.

Similarly, the CPU 1201 determines in the step S1308 whether the inspection result of the product (product inspection result) of the image forming apparatus 101 is normal. From the above, the print inspection result is an inspection result indicating whether the printed matter generated by the image forming apparatus 101 is normal or abnormal, and the product inspection result is an inspection result indicating whether the product of the cut and bound product of the cutting-and-binding apparatus 103 is normal or abnormal.

When the CPU 1201 determines that the printed matter and the cut and bound product are normal, the process proceeds to a step S1309, whereas when the CPU 1201 determines that at least one of them is abnormal, the process proceeds to the step S1310. That is, when all of the job result (S1306), the print inspection result (S1307), and the product inspection result (S1308) are normal, the process proceeds to the step S1309. In the step S1309, the CPU 305 allocate the CO2 emissions to the client (i.e., sets the account for the CO2 emissions to the client).

On the other hand, when any of the job result (S1306), the print inspection result (S1307), and the product inspection result (S1308) is abnormal, the process of the highest process determined as abnormal is set as a determination target, and the process proceeds to the step S1310. The determination target is set to the highest process determined to be abnormal because an abnormality in a lower process may be caused by influence of a higher process. Next, the CPU 1201 determines in the step S1310 whether the image forming apparatus 101 is guaranteed based on the guaranteed determination result. When the CPU 1201 determines that the guarantee of the image forming apparatus 101 is valid (YES), the process proceeds to a step S1311, whereas when the CPU 1201 determines that the guarantee is invalid (NO), the process proceeds to a step S1312.

Then, the CPU 1201 sets in the step S1311 the account for the CO2 emissions to the apparatus manufacturer. On the other hand, the CPU 1201 in the step S1312 set the account for the CO2 emissions to the print contractor.

The first CO2 emissions, which are the CO2 emission of each apparatus, is calculated in the step S1304, and the second CO2 emissions, which are the CO2 emissions of each job, is calculated in the step S1305. The fist CO2 emissions or the second CO2 emissions are allocated to the client in the step S1309. This is because if the first CO2 emissions and the second CO2 emissions are allocated to the client, the CO2 emissions may be allocated redundantly. The CO2 emissions are allocated to the accounts in the same manner in the steps S1311 and S1312.

When all the determination results in the steps S1306 to S1308 are normal, the client of the job in each apparatus is set as the account for the CO2 emissions. Specifically, when the operations of the three image forming apparatuses 101 and the cutting-and-binding apparatus 103 are determined to be normal, the client of each job is set as the account. In a case of a single client, the single client is set as the account for the CO2 emissions of the jobs. In a case of multiple clients, the accounts of the CO2 emissions may be allocated to the clients of the respective jobs. For example, when a client A requests three jobs and a client B requests four jobs, the client A may be set as the account for the CO2 emissions for the three jobs and the client B may be set as the account for the CO2 emissions for the four jobs.

On the other hand, when at least one of the determination results in the steps S1306 to S1308 is abnormal, the manufacturer of the apparatus determined to be abnormal or the contractor of the job that is the cause of the abnormality determination is set as the account for the CO2 emissions. For example, when an operation of a specific apparatus is determined to be abnormal in the step S1306 or S1307 and it is determined that the certain apparatus is guaranteed (“YES” in S1310), the manufacturer of the specific apparatus is set as the account for the CO2 emissions. When the manufacturer of the apparatuses is identical, the identical manufacturer is set as the account for the CO2 emissions.

In addition, when the manufacturers of the apparatuses are different, the CO2 emissions may be allocated to the manufacturers of the respective apparatuses. For example, a case is assumed in which a company X is a manufacture of two image forming apparatuses C and D among the three image forming apparatuses and a company Y is a manufacturer of the remaining one image forming apparatus E. When the apparatus E is determined to be abnormal, the company Y is set as the account of the CO2 emissions. At this time, the CO2 emissions of the apparatus E are allocated to the company Y and the remaining CO2 emissions may be allocated to the client because the remaining apparatuses are normal.

Similarly, in a case of a single contractor, the single contractor is set as the account for the CO2 emissions of the jobs. In addition, in a case of multiple contractors, the accounts of the CO2 emissions may be allocated to the contractors of the respective jobs. For example, it is assumed that a contractor G undertakes three jobs and a contractor H undertakes four jobs. Then, when the job undertaken by the contractor G is determined to be abnormal, the account for the CO2 emissions is allocated to the contractor G. At this time, the CO2 emissions of the three jobs are allocated to the contractor G and the remaining CO2 emissions may be allocated to the client because the remaining jobs are normal.

In addition, as illustrated in FIGS. 14A and 14B described below, the CPU 1201 displays the CO2 emissions (first CO2 emissions) for each apparatus or the CO2 emissions (second CO2 emissions) for each job on the display unit 1206 according to a selection operation of a display button.

FIGS. 14A and 14B are views illustrating examples of CO2 emission display screens in the third embodiment. The CPU 1201 displays the information related to the CO2 emissions collected from the apparatuses on the display unit 1206 as a table 1401, and displays the breakdown information about the CO2 emissions on the display unit 1206 as a table 1402.

Referring back to FIG. 13, the CPU 1201 updates contents displayed on display unit 1206 in a step S1313. Next, the CPU 1201 determines in a step S1314 whether a pressing operation of an update button 1403 is detected. When the CPU 1201 determines that the pressing operation of the update button 1403 is detected (YES), the process proceeds to a step S1315. On the other hand, when the CPU 1201 determines that the pressing operation of the update button 1403 is not detected (NO), the process returns to the step S1301, and the information collection and the calculation and display of the CO2 emissions of the apparatuses are performed again.

Here, the display screens shown in FIGS. 14A and 14B will be described. The screen in FIG. 14A displays the CO2 emissions (first CO2 emissions) of each apparatus within the set period calculated in the step S1304. The screen in FIG. 14B displays the CO2 emissions (second CO2 emissions) of each job within the set period calculated in the step S1305. When detecting a pressing operation of a switching button 1404 shown in FIG. 14A, the CPU 1201 causes the display unit 1206 to display the screen of FIG. 14B. Similarly, when detecting a pressing operation of a switching button 1405 shown in FIG. 14B, the CPU 1201 causes the display unit 1206 to display the screen of FIG. 14A.

FIG. 14A illustrates a state in which the CO2 emissions of the cutting-and-binding apparatus 103, which is one of the apparatuses, are displayed, and FIG. 14B illustrates a state in which the CO2 emissions of the job D, which is an example of the jobs, are displayed. Further, FIG. 14A illustrates a state in which the cutting-and-binding apparatus is selected by the device selection operation in a pull-down menu on the upper right side of the figure. The display screen in FIG. 14A shows that the job D is executed by the cutting-and-binding apparatus 103, the accounts for the CO2 emissions of the job D are allocated to a client company (client) D, a print company (contractor) X, and an apparatus manufacturing company (manufacturer) Y, and the CO2 emissions are allocated to the respective accounts.

The display screen in FIG. 14B shows that any one of the jobs A to D is selectable by an operation and the job D is selected. On the right side of FIG. 14B, detailed breakdowns of the CO2 emissions are displayed.

Then, referring back to FIG. 13, the CPU 1201 determines in the step S1315 whether an end instruction of the CO2 emission calculation application is received. When the CPU 1201 determines that the end instruction is received (YES), the process in FIG. 13 ends. Otherwise (NO), the CPU 1201 shifts the process to the step S1314. The CO2 emissions of a plurality of apparatuses can be consolidated and displayed on the CO2 emission display screens shown in FIGS. 14A and 14B.

Further, the cutting-and-binding apparatus 103 described in the third embodiment is an example of the post-processing apparatus, and the CO2 emissions can be calculated for another post-processing apparatus, the surface treatment apparatus 102, which is a pre-processing apparatus illustrated in FIG. 1, and the inspection apparatus 104. That is, the environmental load calculation server 105 can calculate the CO2 emissions of the image forming apparatus 101 connected to the network 100 in FIG. 1 or another apparatus that executes a process related thereto. An apparatus other than the surface treatment apparatus 102, the cutting-and-binding apparatus 103, and the inspection apparatus 104 may be the other apparatus related to the image forming apparatus 101.

As described above, in the third embodiment, the environmental load calculation server 105 communicably connected to the plurality of image forming apparatuses 101 and the post-processing apparatus (103) can appropriately allocate the CO2 emissions of the apparatuses and the jobs to the accounts such as the client and the print contractor. That is, it is possible to build the environmental load calculation server 105 capable of collectively managing not only one image forming apparatus 101 but also a plurality of image forming apparatuses 101 and post-processing apparatuses so as to calculate and display the CO2 emissions for the respective apparatuses.

Further, the inspection device 108 may be configured to determine that printed matter equal to or higher than a specified level set by the apparatus manufacturer is an accepted product. In such a case, when the CPU 305 determines that the printed matter is an accepted product with the inspection device 108, the CO2 emissions for the accepted product may be allocated to the client. In addition, since the same products are mass-produced in a production line, the CO2 emissions are usually constant. When a defective product is detected by the inspection apparatus 104 that performs the 100% inspection, it is possible to allocate the CO2 emissions to an appropriate account as described in the first embodiment.

Further, the inspection with the inspection apparatus 104 in the production line can be performed by the 100% inspection after production in an off-line state or the sampling inspection. For example, a defect rate of all the products can be roughly estimated from a defect rate obtained by the sampling inspection. In this case, the number of defective products is calculated by multiplying the defect rate to the total number of products, and the CO2 emissions calculated from the obtained number of defective products can be allocated to an appropriate account (for example, the print contractor).

The image forming apparatus 101 executes a plurality of processes including the image forming process according to the given print job to generate printed matter. The CPU 305 (a calculation unit and an allocation unit) calculates CO2 emissions generated in the apparatus and allocates the calculated CO2 emissions to the accounts according to whether the printed matter is normally output. As a result, the CO2 emissions can be allocated to the appropriate accounts based on whether the printed matter is normally output.

According to the present disclosure, an effect is exhibited in which CO2 emissions can be allocated to an appropriate account based on whether printed matter is normally output.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-019405, filed February 7, 2025, which is hereby incorporated by reference herein in its entirety.

What is claimed is:

1. An image forming apparatus generating printed matter by executing a plurality of processes including an image forming process according to a given print job, the image forming apparatus comprising:
a memory device that stores a set of instructions; and
at least one processor that executes the set of instructions to:
calculate CO2 emissions generated in the image forming apparatus; and
allocate the CO2 emissions to an account selected according to whether the printed matter is normally output.

2. The image forming apparatus according to claim 1, wherein the CO2 emissions are calculated based on power consumption in each of the plurality of processes and CO2 emissions for each of consumable parts of the image forming apparatus.

3. The image forming apparatus according to claim 1, wherein the at least one processor executes instructions in the memory device to allocate the CO2 emissions to an account selected according to guarantee information about the image forming apparatus in a case where the printed matter is not normally output.

4. The image forming apparatus according to claim 1, wherein the at least one processor executes instructions in the memory device to:
set a client giving the print job as an account for the CO2 emissions calculated in a case where the printed matter is normally output; and
set a print contractor or an apparatus manufacturer as the account for the CO2 emissions calculated in a case where the printed matter is not normally output.

5. The image forming apparatus according to claim 3, wherein the at least one processor executes instructions in the memory device to:
set an apparatus manufacturer as the account for the CO2 emissions calculated in a case where the printed matter is not normally output and the image forming apparatus is within a guarantee period; and
set a print contractor as the account for the CO2 emissions calculated in a case where the printed matter is not normally output and the image forming apparatus is without the guarantee period.

6. The image forming apparatus according to claim 1, further comprising an inspection device configured to inspect the printed matter and determine whether the printed matter is an accepted product or a rejected product,
wherein the at least one processor executes instructions in the memory device to set a print contractor or an apparatus manufacturer as the account for the CO2 emissions according a cause of rejection in a case where the inspection device determines that the printed matter is a rejected product.

7. The image forming apparatus according to claim 1, further comprising an inspection device configured to inspect the printed matter and determine whether the printed matter is an accepted product or a rejected product,
wherein the at least one processor executes instructions in the memory device to set a print contractor or an apparatus manufacturer as an account for CO2 emissions due to reprinting according a cause of rejection in a case where the inspection device determines that the printed matter is a rejected product.

8. The image forming apparatus according to claim 1, further comprising an inspection device configured to inspect the printed matter and determine that the printed matter is a rejected product in a case where the printed matter is lower than a specified level set by an apparatus manufacturer,
wherein the at least one processor executes instructions in the memory device to set a print contractor as an account for CO2 emissions for the rejected product in a case where the inspection device determines that the printed matter is the rejected product.

9. The image forming apparatus according to claim 1, wherein the at least one processor executes instructions in the memory device to:
register a recovery job in a case where the printed matter is not normally output; and
set a print contractor or an apparatus manufacturer as the account for the CO2 emissions generated due to execution of the recovery job according guarantee information about the image forming apparatus.

10. A control method for an image forming apparatus generating printed matter by executing a plurality of processes including an image forming process according to a given print job, the control method comprising:
calculating CO2 emissions generated in the image forming apparatus; and
allocating the CO2 emissions calculated to accounts according to whether the printed matter is normally output.

11. A non-transitory computer-readable storage medium storing a control program causing a computer to execute a control method for an image forming apparatus generating printed matter by executing a plurality of processes including an image forming process according to a given print job, the control method comprising:
calculating CO2 emissions generated in the image forming apparatus; and
allocating the CO2 emissions calculated to accounts according to whether the printed matter is normally output.
